(19) United States
(12) Patent Application Publication
(10) Pub. No.: US 2023/0129091 A1
(43) Pub. Date: Apr. 27, 2023

(54) NON-GPS BASED NAVIGATION AND MAPPING BY AUTONOMOUS VEHICLES

(71) Applicant: INTERNATIONAL BUSINESS MACHINES CORPORATION, Armonk, NY (US)

(72) Inventors: Malwina Bajsarowicz, Miloszyce (PL); Mary Kathryn Aldridge, Washington, DC (US); Thuy Luong, Kellyville (AU); James David Cleaver, Grose Wold (AU); Michael James McGuire, Sydney (AU)

(21) Appl. No.: 17/507,298

(22) Filed: Oct. 21, 2021

(51) Int. Cl. G05D 1/02; B60W 60/00; G01C 21/00

(52) U.S. Cl. CPC G05D 1/0274; B60W 60/001; G01C 21/3807; G05D 1/0234

(57) ABSTRACT

Systems and methods enable autonomous vehicles to navigate and generate maps in a GPS-free environment. In embodiments, a method includes: continuously obtaining real-time environment data from one or more sensing devices of the autonomous vehicle during a navigation event in an exploration area; identifying physical attributes of the exploration area based on the real-time environmental data; navigating within the exploration area during the navigation event using machine learning by: assigning scores to multiple possible paths based on a probability of success of one or more desired outcomes for each of the possible paths; selecting one of the possible paths based on the scores; and moving the autonomous vehicle according to the selected one of the possible paths; and building a navigation map of the exploration area based on the physical attributes.

### BACKGROUND

Aspects of the present invention relate generally to autonomous vehicle navigation and, more particularly, to non-global positioning system (GPS) based navigation and mapping of physical locations by autonomous vehicles.

Autonomous vehicles, such as land-based mobile robots, unmanned aerial vehicles (UAVs) and autonomous underwater vehicles (AUVs), have been developed for numerous uses, including detecting objects in physical environments. Some autonomous vehicles are configured to navigate without the use of global positions systems (GPS) data. One example is a UAV that navigates utilizing a beacon signal at a target location.

Cartography is the study and practice of making and using maps. Various computer-based methods have been utilized to generate maps, including the use of aerial images to create ground survey maps.

### SUMMARY

In a first aspect of the invention, there is a computer-implemented method including: continuously obtaining, by an autonomous vehicle, real-time environment data from one or more sensing devices of the autonomous vehicle during a navigation event in an exploration area; identifying, by the autonomous vehicle, physical attributes of the exploration area based on an analysis of the real-time environmental data; navigating, by the autonomous vehicle, within the exploration area during the navigation event using machine learning by: assigning scores to multiple possible paths based on a probability of success of one or more desired outcomes for each of the possible paths; selecting one of the possible paths based on the scores; and moving the autonomous vehicle according to the selected one of the possible paths; and building, by the autonomous vehicle, a navigation map of the exploration area based on the physical attributes.

In another aspect of the invention, there is a computer program product including one or more computer readable storage media having program instructions collectively stored on the one or more computer readable storage media. The program instructions are executable to cause an autonomous vehicle to: continuously obtain real-time environment data from one or more sensing devices of the autonomous vehicle during a navigation event in an exploration area, wherein global positioning system (GPS) data is unavailable to the autonomous vehicle during the navigation event; identify physical attributes of the exploration area based on an analysis of the real-time environmental data; navigate within the exploration area during the navigation event using machine learning to select a path to travel from among multiple possible paths based on the physical attributes, wherein the navigating results in the autonomous vehicle changing directions while traveling through the exploration area during the navigation event; building, by the autonomous vehicle, a navigation map of the exploration area over time during the navigation event based on the physical attributes; writing digital data to a marker, the digital data providing information regarding the navigation; and placing and leaving the marker at a target location in the exploration area.

In another aspect of the invention, there is system including a processor, a computer readable memory, one or more computer readable storage media, and program instructions collectively stored on the one or more computer readable storage media. The program instructions are executable to cause an autonomous vehicle to: continuously obtain real-time environment data from one or more sensing devices of the autonomous vehicle during a navigation event in an exploration area, wherein global positioning system (GPS) data is unavailable to the autonomous vehicle during the navigation event; identify physical attributes of the exploration area based on the real-time environmental data; identify reference points based on the physical attributes of the exploration area using a trained machine learning (ML) algorithm; navigate within the exploration area during the navigation event by: assigning scores to multiple possible paths based on a probability of success of one or more desired outcomes for each of the possible paths; selecting one of the possible paths based on the scores; and moving the autonomous vehicle according to the selected one of the possible paths; and build a navigation map of the exploration area over time during the navigation event based on the physical attributes and the reference points.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIGS. 5A-5B show a flowchart of an exemplary autonomous vehicle method in accordance with aspects of the invention.

FIG. 6 shows a flowchart of an exemplary central server method in accordance with aspects of the invention.

FIG. 7 shows a flowchart of an exemplary hand-held device method in accordance with aspects of the invention.

FIG. 8 is a diagram representing navigation through an obstacle-filled environment using a first maze solving method.

FIG. 9 is a diagram representing navigation through an obstacle-filled environment using a machine learning (ML) curiosity method in accordance with aspects of the invention.

FIG. 10 illustrates an exemplary autonomous vehicle in accordance with aspects of the invention.

### DETAILED DESCRIPTION

Aspects of the present invention relate generally to autonomous vehicle navigation and, more particularly, to non-global positioning system (GPS) based navigation and mapping of physical locations by autonomous vehicles. In embodiments, systems, methods and computer program products are provided that enable automated navigation and mapping of a physical location by an un-manned autonomous vehicle, such as land-based mobile robots, unmanned aerial vehicles (UAVs) or drones, and autonomous underwater vehicles (AUVs).

There are several situations where navigation without access to GPS or other remote navigational assistance can arise. These include situations such as underwater navigation, navigation in caves, or in the event that the GPS systems are rendered unavailable such as times of natural disasters. In addition, there are often times where areas are not mapped due to changes in terrain over time, and an accurate map requires knowledge of the changes in terrain over a period of time (e.g., water rising in a cave).

An algorithm for navigating through a maze or series of obstacles (e.g., a cave system, underwater tunnels, wreckage) may be focused on a single goal of locating a resource (survivor, target, etc.). Alternatively, an algorithm for navigating through a maze or series of obstacles may be focused on finding the shortest path to exit the maze. Some methods of autonomous vehicle or drone navigation through a maze (e.g., cave) utilize predefined direction-based turns (e.g., always take the left path or follow the left wall). This type of method allows the autonomous vehicle to solve the maze (i.e., escape a cave). However, in real-life scenarios, an autonomous vehicle may have competing priorities (e.g., exit the cave system, and locate survivors). Always following the left path, for example, would result in exiting the cave system, but would not maximize the ability to meet the other criteria (i.e., locate survivors).

In accordance with embodiments of the invention, a navigation method includes an element of curiosity, which enables an autonomous vehicle to “quickly try other paths.” For example, while an autonomous vehicle may be programed with default instructions to continue left, which would guarantee an exit, the autonomous vehicle may deviate from the default instructions and instead start down an alternative path for a period of time to determine what is there, before turning back to the primary route (i.e., continuing left). In implementation, the use of multiple autonomous vehicles expands or intensifies the results of such a method, by essentially dividing and conquering an exploration area, while individually applying the navigation method including curiosity. Thus, embodiments of the invention enable navigation without outside assistants from navigation systems such as GPS, and enable navigation for exploration missions with multiple goals (e.g., optimize fuel usage, find as many survivors as possible, avoid potential hazards, etc.).

In aspects of the invention, a method is provided for exploring areas where a satellite based GPS system or other outside navigation system is not available, such as in caves, tunnels, mines, sewage systems, buildings, etc. In embodiments, the method may be utilized with the aim of rescuing people or recovering objects or devices. In implementations, an autonomous moving device (e.g., hereafter autonomous vehicle) is utilized, which may include one or more sensors, (e.g., cameras, radar, light detection and ranging (lidar) devices, etc.) for sensing an area to be explored during an exploration event with a defined starting point. In aspects of the invention, during the exploration event, the autonomous vehicle starts moving towards an objective, destination or aim, and makes navigation decisions to move the autonomous vehicle directionally within the exploration area based on one or more objectives, destinations or aims. In embodiments of the invention, the autonomous vehicle uses sensors to identify reference points based on a trained/trainable machine learning (ML) algorithm, and creates a navigation map based on the movement of the autonomous vehicle, actual positions of the autonomous vehicle, the reference points, and the data from the one or more sensors. In implementations, the autonomous vehicle identifies a previous path which was traversed by the autonomous vehicle based on the starting point, the reference points and the navigation map. In embodiments, the autonomous vehicle is configured to encode the previous path of the autonomous moving vehicle and additional data (device identification (ID), etc.) in one or more electronic markers, which may be dropped or otherwise placed by the autonomous vehicle at one or more locations within the exploration area to create reference points. In aspects of the invention, the autonomous vehicle recognizes if a destination is reached, and returns to the starting point using known reference points and the navigation map to navigate through the exploration area.

In implementations, an autonomous vehicle may include: at least one video or digital image recording device and an image recognition system for processing image data from the video or digital image recording device; at least one kind of sensor for measuring conditions in a physical location/area; at least one kind of sensor (e.g., radar, lidar, etc.) for measuring the distance from the autonomous vehicle to objects; at least one processing device for processing incoming data; at least one storage device for storing data; at least one machine learning algorithm module (e.g., a curiosity algorithm module) configured to learn to identify reference points within the physical location/area and create wireframes based on the incoming data produced by the video or digital image recording device and the sensors; at least one illumination system (e.g., an ultra violet (UV) light); at least one kind of near device communication reader (e.g., near-field communication (NFC), Bluetooth, etc.); at least one kind of near device communication writer (e.g., NFC writer); a marker or tag producing device for producing or writing data to near device communications reader readable markers or tags (e.g., an electronic marker); and at least one autonomous moving system capable of moving the autonomous vehicle within an area (e.g., motors, wheels, propellers, blades, etc.).

Embodiments of the invention provide improved autonomous vehicles, improved autonomous vehicle navigation and mapping methods, and improved computer program products for autonomous vehicles. In implementations, a specialized computing device in the form of an autonomous vehicle is configured to implement trained and/or trainable ML algorithms to make navigation decisions based on real-time incoming data from sensing devices (e.g., accelerometers, digital cameras, proximity sensors, etc.). Aspects of the invention provide a technical solution to the problem of autonomous device navigation in a GPS-free obstacle-filled environment for the purpose of meeting a plurality of goals, objectives or targets.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

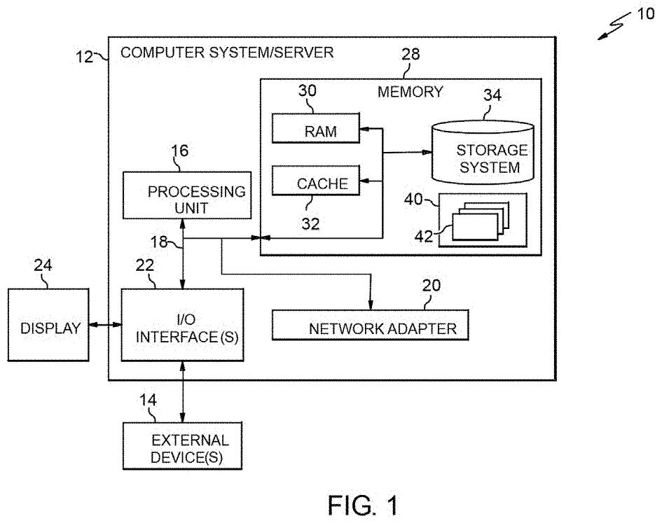

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

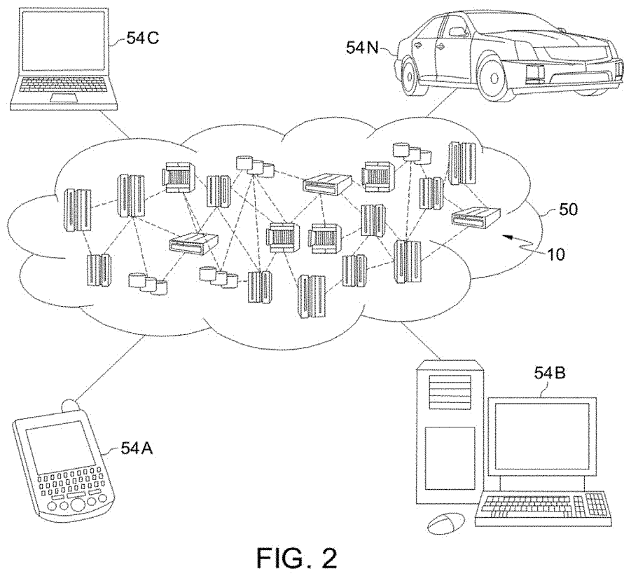

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

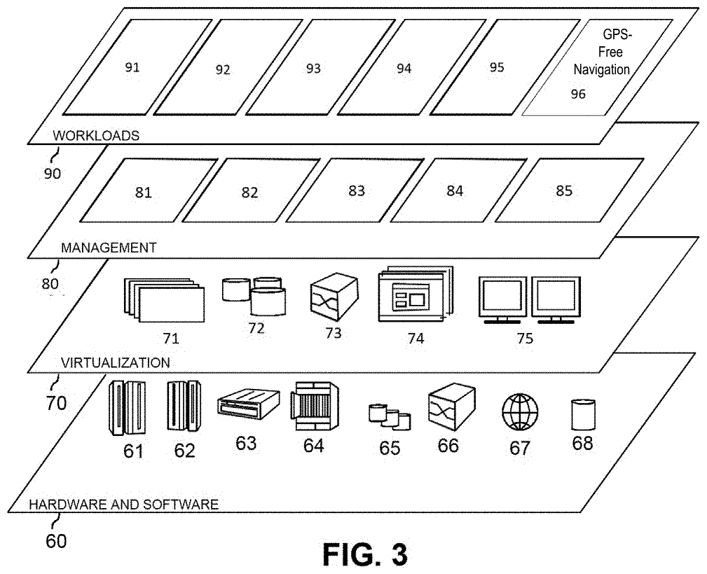

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and GPS-free navigation 96.

Implementations of the invention may include a computer system/server 12 of FIG. 1 in which one or more of the program modules 42 are configured to perform (or cause the computer system/server 12 to perform) one of more functions of the GPS-free navigation 96 of FIG. 3. For example, the one or more of the program modules 42 may be configured to cause an autonomous vehicle to: start navigation from a starting location towards an object; take images and identify reference points (using a system trained in identifying reference points); keep track of the images and the reference points for navigation; if the vehicle cannot identify a reference point, identify a best location (target location) to place an electronic marker (using a system trained to identify candidate locations for placing electronic markers); encode previous path data and additional data, including an identification (ID), etc., to the electronic marker; drop or place the electronic marker at a location; continue navigating to a destination; return to the starting point or base using known image reference points; use illumination to find an electronic marker when near its location (e.g., using NFC to identify the location of the electronic marker); and improve search capabilities of the autonomous vehicle using ML curiosity method.

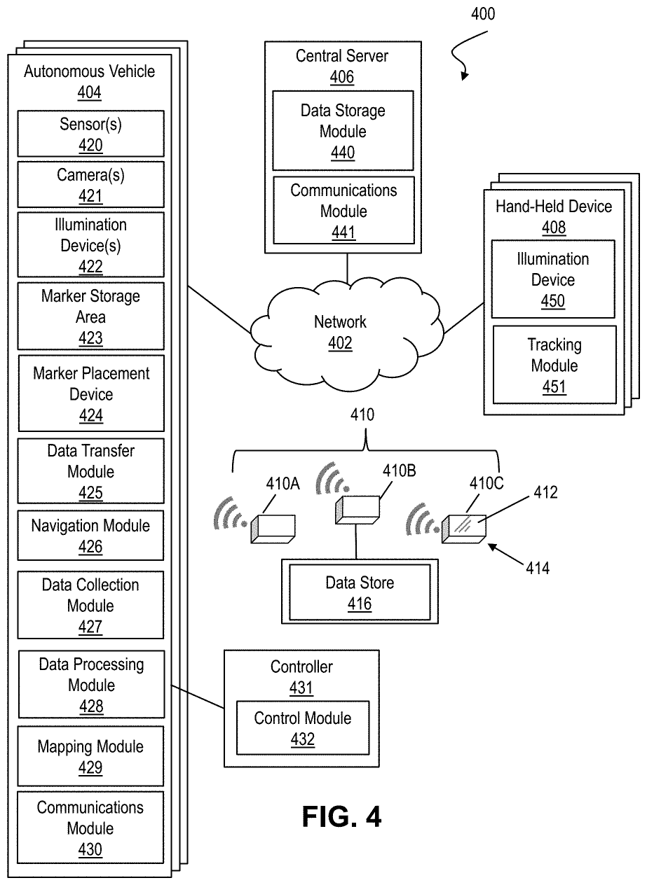

FIG. 4 shows a block diagram of an environment 400 in accordance with aspects of the invention. In embodiments, the environment 400 includes a network 402 enabling communication between one or more autonomous vehicles represented at 404, a central server 406 and one or more hand-held devices 408. In implementations, the network 402 is a near device communications network. In other implementations, the network 402 comprises the Internet. Various types of networks may be utilized in implementations of the invention, and the invention is not intended to be limited to network examples described herein.

The environment 400 of FIG. 4 also includes markers 410, which may be in the form of electronic markers having a memory or data store (e.g., data store 416) to provide autonomous vehicles 404 with digital information/data obtained by another autonomous vehicle. By way of example, FIG. 4 depicts a first electronic marker 410A, a second electronic marker 410B and a third electronic marker 410C.

In implementations, the markers 410 are designed to store navigation data (e.g., location and mission data) for sharing with autonomous vehicles 404. In embodiments, the markers 410 are configured to be read and updated by autonomous vehicles 404. In one example, the markers 410 may be utilized in a complex cave system where different autonomous vehicles have travelled different routes, and each autonomous vehicle 402 may update the markers 410 with additional navigational knowledge they have obtained. These communications of information may be encrypted both in transmission and whilst stored on a marker 410.

In embodiments, an electronic marker (e.g., 410A) is a small lightweight component that is highly reflective in at least a small spectrum of wavelength, and contains a digital reference and a unique tracking number that an autonomous vehicle 404 is able to use as a reference point. In implementations, the markers 410 store historic data of where an autonomous vehicle 404 has been, and where it had intended on going next, so that in the event of losing the autonomous vehicle 404, the autonomous vehicle 404 can be tracked.

As illustrated by the marker 410C in FIG. 4, in implementations, the markers 410 include a reflective coating 412 on an outer surface of a housing 414, enabling sensors of automated vehicles 404 to detect the markers 410 and, optionally, obtain data from the data store 416 of the markers 410. In embodiments, the reflective coating 412 is only visible with ultra violet (UV) light. The markers 410 may comprise a passive data store readable by a reading device of an automated vehicle 404. In embodiments, the data store 416 of the electronic markers 410 comprises a passive data store in the form of an NFC tag enabling the contactless exchange of data with NFC readers of autonomous vehicles 404.

The one or more autonomous vehicles 404 may each comprise elements of the computer system/server 12 of FIG. 1, such as a processing unit 16 and memory 28. In implementations, the autonomous vehicle 404 may be configured to communicate in the cloud environment 50 of FIG. 2 when a network connection is available to the autonomous vehicle 404. In implementations, the autonomous vehicle 404 may include various hardware components, such as one or more sensors 420, one or more digital image cameras 421 (e.g., video or still image cameras), one or more illumination devices 422 (e.g., an ultraviolet (UV) light and/or visible light), a maker storage area 423 configured to store markers 410, and a marker placement device 424 configured to place markers in a physical environment.

The one or more sensors 420 may comprise a radar device, a lidar device, accelerometers, or other sensors to provide data regarding the autonomous vehicles 404 surrounding environment or movements of the autonomous vehicle 404 within a physical area being explored by the autonomous vehicle 404. The marker storage area 423 may any be type of marker holding and/or containment system. Similarly, the marker placement device 424 may be any type of maker dispensing and/or placement device. By way of example, an autonomous vehicle 404 according to embodiments of the invention may include racks of markers that may be advanced through a dispensing mechanism through a selectively opened dispensing door formed in a marker storage housing, whereby markers are selectively dispensed through the door to a location beneath or adjacent to the autonomous vehicle 404. It should be understood that various types of autonomous vehicles 404, including land-based mobile robots, unmanned aerial vehicles (UAVs) and autonomous underwater vehicles (AUVs), may be retrofitted or otherwise configured for use with the present invention. To that end, computer program products according to aspects of the invention may be utilized with various types of unmanned vehicles 404 to cause the unmanned vehicles 404 to perform automated navigation and map generation in GPS-denied environments as discussed herein.

In embodiments, the one or more autonomous vehicles 404 include one or more modules, each of which may comprise one or more program modules such as program modules 42 described with respect to FIG. 1. In the example of FIG. 4, the one or more autonomous vehicles 404 include: a data transfer module 425, a navigation module 426, a data collection module 427, a data processing module 428, a mapping module 429, and a communication module 430, each of which may be a program module 42 of FIG. 1.

In implementations, the data transfer module 425 is configured to transfer navigation data and other data to a marker 410 before the marker 410 is placed at a select location (target location) by an automated vehicle 404 in an exploration area. In embodiments, the navigation module 426 is configured to utilize machine learning algorithms to make navigation decisions for an autonomous vehicle 404 based on the receipt of real-time environment data gathered by the one or more sensors 420 and the one or more cameras 421.

In aspects of the invention, the data collection module 427 is configured to collect the real-time environment data from the one or more sensors 420 and the one or more cameras 421. In embodiments, the data processing module 428 is configured to process the data collected by the data collection module 427 to identify physical attributes of an area and to further identify reference points for use in navigation.

In implementations, the mapping module 429 is configured to generate a map of a physical area (e.g., a relief map such as a topographical map or bathymetric map, or a three dimensional wireframe map) based on the data processed by the data processing module 428. In aspects, the communications module 430 is configured to communicate with one or more remote devices, such as the central server 406, hand-held device 408 and/or the markers 410 through device-to-device communication or via an available network.

In embodiments, an autonomous vehicle 404 includes a controller 431 including a control module 432 with programming for the control of the autonomous vehicle 404 (e.g., in the form of program modules 42 of FIG. 1). The controller 431 may be incorporated into the autonomous vehicle 404, and/or may be separate from the autonomous vehicle 404 and communicate with the autonomous vehicle 404 via a wireless or wired connection. The control module 432 may include a user interface enabling a user to enter control commands or other data via an input device (e.g., keyboard or touchscreen).

In embodiments of the invention, the central server 406 comprises the computer system/server 12 of FIG. 1, or elements thereof. The central server 406 may be a computing node 10 in the cloud computing environment 50 of FIG. 2. In implementations, the central server 406 includes a data storage module 440 for storing navigational data generated by the one or more autonomous vehicles 404 (e.g., relief maps, physical attributes, attributes of the autonomous vehicles, etc.) and/or trained machine learning algorithms for use by the one or more autonomous vehicles 404. In embodiments, the central server 406 includes a communications module 441 configured to allow the communication of data between the one or more autonomous vehicles 404 and/or the one or more hand-held devices 408, and the central server 406. The data storage module 440 may be in the form of the memory 28 of FIG. 1, and the communications module 441 may comprise the program module 42 and the Input/Output (I/O) interfaces 22 of FIG. 1.

In embodiments of the invention, the hand-held device 408 comprises the computer system/server 12 of FIG. 1, or elements thereof. The hand-held device 408 may be a computing device used by cloud consumers in the cloud environment 50 of FIG. 2, such as a cellular telephone 54A. In embodiments, the hand-held device 408 includes elements enabling it to track electronic markers (e.g., 410B). In implementations, the hand-held device 408 includes an illumination device 450 (e.g., a mobile device flashlight, or an UV light) and a tracking module 451 configured to enable a user to navigate an exploration area utilizing information from one or more maps generated by one or more autonomous vehicles 404 according to embodiments of the invention. The term exploration area as used herein refers to a physical location or area (geographic area) within which an automated vehicle 404 navigates during a navigation event and/or which a user navigates with a hand-held device 408 during a user navigation event. An exploration area may include airspace, land, water or a combination thereof. The tracking module 451 may comprise the program module 42 of FIG. 1, and may be configured to display a map of an area to a user to assist the user in navigating the area in the absence of GPS guidance or the like.

It should be understood that each of the one or more autonomous vehicles, central server 406, hand-held device 408 and markers 410 may include additional or fewer modules or features than those shown in FIG. 4. In embodiments, separate modules may be integrated into a single module. Additionally, or alternatively, a single module may be implemented as multiple modules. Moreover, the quantity of devices and/or networks in the environment 400 is not limited to what is shown in FIG. 4. In practice, the environment may include additional devices and/or networks; fewer devices and/or networks; different devices and/or networks; or differently arranged devices and/or networks than illustrated in FIG. 4.

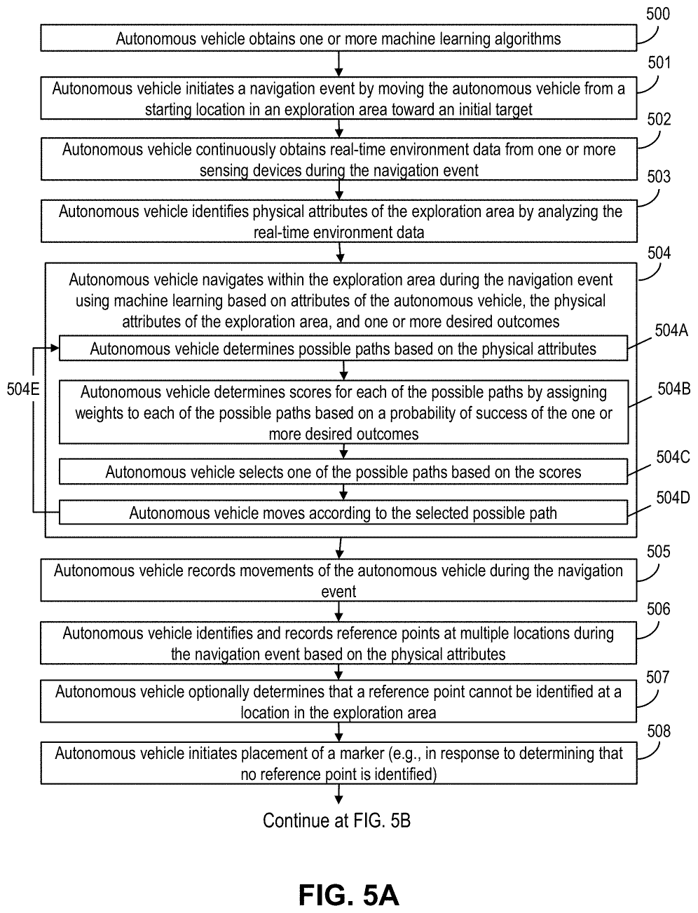

FIGS. 5A-5B show a flowchart of an exemplary autonomous vehicle method in accordance with aspects of the present invention. Steps of the method may be carried out in the environment of FIG. 4 and are described with reference to elements depicted in FIG. 4. Unless otherwise indicated below, steps of FIG. 5 need not be performed in the order shown in the flowchart.

With initial reference to FIG. 5A, at step 500, the autonomous vehicle 404 obtains one or more machine learning (ML) algorithms to assist in independent navigation by the autonomous vehicle 404. In aspects of the invention, the autonomous vehicle 404 obtains one or more ML algorithms trained for a type of environment which matches the type of environment to be explored by the autonomous vehicle 404. The ML algorithms may be obtained by the autonomous vehicle 404 from the data storage module 440 of the central server 406 through the network 402. By way of example, a user may select from a plurality of trained ML algorithms stored at the central server 406 based on the type of environment to be explored, such as a cave system, building, natural disaster area, underwater area, etc. In embodiments, the communications module 430 of the autonomous vehicle 404 implements step 500 and stores the one or more ML algorithms for use by the data processing module 428.

At step 501, the autonomous vehicle 404 initiates a navigation event by moving the autonomous vehicle from a starting location in an exploration area toward an initial target. The term navigation event as used herein refers to an event occurring over a period of time wherein the autonomous vehicles 404 self-navigates through a physical area from the starting location to an end location (which may be the staring location in the event of a round-trip navigation event). In implementations, the navigation event is performed in the absence of GPS data or other remote navigational assistance obtained over a network connection. In embodiments, the method is performed in an exploration area without network connectivity (e.g., no Internet connection). A user may utilize the controller 431 to initiate a navigation event in accordance with step 501. In embodiments, the navigation module 426 of the autonomous vehicle 404 implements step 501 (e.g., based on a user command received via the controller 431).

At step 502, the autonomous vehicle 404 continuously obtains real-time environment data generated from local sensor data obtained during the navigation event from one or more sensing devices (e.g., the one or more sensors 420 and cameras 421 of FIG. 4). The term local sensor data as used herein refers to data obtained from sensing local attributes using sensors of one or more sensing devices, and excludes data obtained from outside sources. In embodiments, the sensing devices may be any time of device of the autonomous vehicle 404 that provides information regarding the surrounding physical environment, such as the distance to objects, the shape and location of nearby objects (e.g., objects within the range of the sensing device(s)), and changes to nearby objects over time (e.g., moving objects, rising water levels, etc.). In embodiments, the data collection module 427 of the autonomous vehicle 404 implements step 502 by collecting data from the one or more sensors 420 and the one or more cameras 421.

At step 503, the autonomous vehicle 404 identifies physical attributes of the exploration area by analyzing the real-time environment data during the course of the navigation event. In embodiments, the data processing module 428 of the autonomous vehicle 404 implements step 503 after obtaining the real-time environment data from the data collection module 427. The autonomous vehicle may utilize natural language processing techniques, image processing techniques, object recognition techniques, and other data processing techniques to determine the physical attributes of the exploration area.

In implementations, the autonomous vehicle 404 utilizes a trained ML environment algorithm during the analyzing of the real-time environment data. In implementations, the ML environment algorithm is one of the ML algorithms obtained by the autonomous vehicle 404 at step 500. For example, an ML environment algorithm may be trained for the particular type of environment (e.g., underwater, cave, terrestrial above-ground environment, natural disaster environment, building, etc.) matching the navigation environment. In such cases, the ML environment algorithm enables the data processing module 428 to interpret incoming real-time environment data to identify changes in terrain, objects, and states of objects of elements, for example. In one example, the ML environment algorithm enables image recognition processing of digital image data from one or more cameras 421 to identify changes in terrain, types of objects (e.g., trees, rocks, water), and states of objects of elements (e.g., moving or rising water, unstable or moving rock slides, mud, etc.).

In certain embodiments, the autonomous vehicle 404 may perform in situ training of the ML navigation algorithm during the exploration event. For example, the data processing module 428 may implement image recognition techniques to determine that a rock slide area is shifting or moving periodically, and is therefore unstable. The data processing module 428 may then train the ML navigation algorithm to recognize similar rock slide areas as unstable and unsuitable for possible pathways through the exploration environment.

At step 504, the autonomous vehicle 404 navigates within the exploration area during the navigation event using a ML navigation algorithm (also referred to as the ML curiosity method), based on attributes of the autonomous vehicle, the physical attributes determined at step 503, and one or more desired outcomes. In implementations, the ML navigation algorithm is one of the ML algorithms obtained by the autonomous vehicle 404 at step 500. Attributes of the autonomous vehicle 404 could include, for example, the fuel or power requirements of the autonomous vehicle 404, ground clearance, proportions, power, or other factors effecting the ability of the autonomous vehicle 404 to navigate around or through obstacles in an exploration area.

A user may program the autonomous vehicle 404 with one or more desired outcomes, or the one or more desired outcomes may be included with the ML navigation algorithm. By way of example, desired outcomes may include obtaining a fuel or power source for the autonomous vehicle 404 as necessary during the navigation event, searching for people or objects within the exploration area, meeting certain timelines (e.g., search and rescue timelines), avoiding potential hazards, navigating to a certain end location from the starting location, etc. In embodiments, the navigation module 426 of the autonomous vehicle 404 implements step 504. In implementations, step 504 includes the following substeps 504A-504E.

At substep 504A, the autonomous vehicle determines possible paths based on the physical attributes and the attributes of the autonomous vehicle. For example, the autonomous vehicle may determine, for the particular make and model of autonomous vehicle 404, a relatively obstacle free path from its current location to a remote location based on the physical attributes identified from the incoming real-time environment data.

At substep 504B, the autonomous vehicle 404 scores each of the possible paths by assigning weights to each of the possible paths based on a probability of success of the one or more desired outcomes for each of the possible paths. In aspects, the probability of success is based on the physical attributes (e.g., obstacles, hazards, etc.) and the attributes of the autonomous vehicle 404 (e.g., ability to navigate over, around or through obstacles, hazards, etc.). In one example, an autonomous vehicle 404 has a first goal of navigating to a power source and a second goal of searching for people within the exploration area. In this example, a first possible path meets the first goal with high probability of success, but meets the second goal with a very low probability of success, based on the physical attributes of the exploration environment and the attributes of the autonomous vehicle 404. A second possible path meets both the first and second goals with a high probabilities of success. In this example, the weighting applied to the two goals results in the second possible path having a higher score (e.g., sum of the weighted goals) than the first possible path, indicating that the second possible path is the path most likely to result in successful completion of both goals.

At substep 504C, the autonomous vehicle 404 selects one of the possible paths based on the scores determine at substep 504B. Using the example of substep 504B, the autonomous vehicle 404 selects the second possible path to use in navigation over the first possible path.

At substep 504D, the autonomous vehicle 404 moves through the exploration area according to the possible path selected at substep 504C. Using the previous example of substep 504C, the autonomous vehicle 404 follows the second possible path through the exploration area from its current location to an end location of the second possible path. It should be understood that substeps 504A-504D may be repeated continuously as the autonomous vehicle navigates through the exploration area during the navigation event as indicated by arrow 504E.

At step 505, the autonomous vehicle 404 records its movements during the navigation event. In implementations, movement may be relative to the starting point or reference points identified according to step 506. In embodiments, the mapping module 429 of the autonomous vehicle 404 implements step 505.

At step 506, the autonomous vehicle 404 identifies and records reference points at multiple locations within the exploration area during the navigation event based on the physical attributes. In implementations, the autonomous vehicle 404 identifies and records a reference point during navigation according to predetermine rules, such as at every distance D traveled. In implementations, ML, is used for the autonomous vehicle 404 to learn what an appropriate landmark is in the terrain of the exploration area (be it caves, under water, on land, or where ever the system is operating). In one example, an empty drink can on the ground would not be suitable as it is not a fixed object.

In implementations, the ML environment algorithm is trained to identify a reference point based on incoming real-time environment data. In embodiments, the ML environment algorithm is trained to distinguish between fixed or stationary objects and non-fixed or movable objects. For example, the ML environment algorithm may be trained to identify trees as fixed objects, and trash (e.g., a plastic water bottle) as a non-fixed object. In this case, the autonomous vehicle 404 may identify the tree (fixed object) as a reference point that may be utilized by the autonomous vehicle 404 to create a navigation map. In embodiments, the data processing module 428 of the autonomous vehicle 404 implements step 506.

At step 507, the autonomous vehicle 404 optionally determines that a reference point cannot be identified at a location in the exploration area. In one example, the autonomous vehicle 404 determines that a reference point is necessary for mapping according to predetermined rules, but cannot identify any reference point at a particular location based on the incoming real-time environment data. For example, the autonomous vehicle 404 may determine that no reference points are available at a particular location in the exploration area when the location is relatively flat with no landmarks. In embodiments, the data processing module 428 of the autonomous vehicle 404 implements step 507.

At step 508, the autonomous vehicle 404 initiates placement of a marker 410 (e.g., an electronic marker 410B). In embodiments, the autonomous vehicle 404 initiates placement of a marker 410 in response to the determination at step 507 that a reference point cannot be identified (e.g., is not available). In embodiments, the mapping module 429 of the autonomous vehicle 404 implements step 508.

Turning to FIG. 5B, at step 509, the autonomous vehicle 404 writes navigation data to a first marker in response to step 508. The navigation data may include data regarding past movements or anticipated future movements of the autonomous vehicle 404 within the exploration area, and or one or more navigation maps. The navigation data may also include other data, such as an identification (ID) of the autonomous vehicle 404 performing step 509, date, time, or other information potentially pertinent to the navigation of the exploration area by another autonomous vehicle. In embodiments, the marker 410 is in the form of a near field communication (NFC) or other near device communication (NDC) device, configured to store data to be read by one or more autonomous vehicles 404. In such cases, the autonomous vehicle 404 utilizes a NFC or other NDC writer to write the navigation data to a data store (e.g., data store 416) of the first marker. In implementations, a data writer is positioned adjacent the marker storage area 423 for accessing and writing data to the markers 410 stored therein. In embodiments, the data transfer module 425 of the autonomous vehicle 404 implements step 509.

At step 510, the autonomous vehicle 404 places the first marker at a first location in the exploration area and records the location as a reference point. In embodiments, the marker placement device (e.g., a moving arm) moves the first marker from the marker storage area 423 of the autonomous vehicle to the location outside of the autonomous vehicle (e.g., through a door on the marker storage area 423), and the mapping module 429 records the location of the reference point according to step 510. The term “places the first marker” refers to moving the first marker from the marker storage areas 423 to a location outside the autonomous vehicle 404, and can include dropping the first marker, positioning the first marker by a mechanical means, dispensing the first marker, or other methods of transferring an object, and the invention is not intended to be limited by the methods discussed herein.

In embodiments, navigation data obtained by the autonomous vehicle 404 during the navigation event (e.g., the navigation map, physical attributes, reference points, etc.) includes a predictive time element, such that the navigation data can reflect that a certain path or route may only be available for a certain amount of time (e.g., due to water level rising).

By utilizing both digital images and the markers 410, the autonomous vehicle 404 is able to map its surrounding and identify paths to return to its base or final destination without the aid of GPS. In implementations, the autonomous vehicle 404 can make use of inertial navigation systems to determine direction and distance from previously dropped electronic markers. In aspects of the invention, the autonomous vehicle 404 can encode or mark the location of interesting objects (e.g. people to be rescued) in the markers 410.

In embodiments, the autonomous vehicle 404 can identify candidate locations to place the first marker based on the physical attributes of the area. For example, the autonomous vehicle 404 may utilize a ML algorithm (e.g., ML environment algorithm) to determine that a flat portion of ground surrounded by tall objects would not be a candidate location because it would be difficult for an autonomous vehicle 404 or a hand-held device 408 to detect a first marker screened by the tall objects. Conversely, the autonomous vehicle 404 may determine that a flat portion of ground that is not obscured from view by any tall objects is a good candidate location for placement of a marker 410.

At step 511, the autonomous vehicle 404 updates (e.g., trains) one or more ML algorithms based on the real-time environmental data obtained during the navigation event and rules. In embodiments, a ML environment algorithm for a particular type of environment may be further trained in situ within such an environment by the autonomous vehicle 404. For example, as discussed above, the data processing module 428 may implement image recognition techniques to determine that a rock slide area is shifting or moving periodically, and is therefore unstable. The data processing module 428 may then train the ML navigation algorithm to recognize similar rock slide areas as unstable and unsuitable for possible pathways through the exploration environment. In embodiments, the data processing module 428 of the autonomous vehicle 404 implements step 511.

At step 512, the autonomous vehicle 404 generates and stores a navigation map (e.g., relief map or wireframe map) of the exploration area based on the movement of the autonomous vehicle 404 during the navigation event, the physical attributes, and the reference points. In implementation, the autonomous vehicle 404 builds the navigation map over time during the navigation event, such that portions of the navigation map may be generated at different times during the navigation event. In embodiments, the autonomous vehicle 404 relies on image recognition and ML algorithms to create a wire frame of the topography of the exploration area for navigational purposes. In aspects of the invention, as the autonomous vehicle 404 moves forward it identifies new topographical vectors and relates them back to the original image (e.g., digital image from a camera) to keep track of the current location of the autonomous vehicle 404. In aspects, the map is stored on the markers 410 as it is generated, so that other autonomous vehicles 404 or hand-held device 408 users can obtain the map as it existed at a point in time.

In implementations, a cartographical function of the autonomous vehicle 404 maps terrain and identifies secure and/or safe places to place markers 410, and builds a navigation map of the environment over time. For example an autonomous vehicle 404 (e.g., a drone) may assess a path in a cave and may determine that the path is only suitable for placing markers 410 for the next 4 hours before the cave completely floods. The markers 410 may include the navigation map as it exists at a particular point in time during the navigation event. Various map generating methods may be utilized in accordance with the invention, and the invention is not intended to be limited to any one type of computer-generated mapping method or tool. In embodiments, the mapping module 429 of the autonomous vehicle 404 implements step 512.

At step 513, optionally, the autonomous vehicle 404 identifies a secondary marker (e.g., placed by another autonomous vehicle) at a location in the exploration area. In implementations, the autonomous vehicle 404 activates an illumination device 422 (e.g., flashlight function) to shine a light (e.g., UV light) around the autonomous vehicle. In implementations, the data processing module 428 processes data from one or more sensors 420 indicating the light is reflecting back from a reflective coating 412 of a secondary marker (e.g., marker 410C), and identifies the location of the secondary marker based on the data. In embodiments, the data processing module 428 of the autonomous vehicle 404 implements step 513.

At step 514, optionally, the autonomous vehicle 404 navigates to the secondary marker in response to the identification of the secondary marker at step 513. In embodiments, navigating to the secondary marker becomes another of the one or more desired outcomes which is considered by the autonomous vehicle during the navigation of step 504. In such embodiments, the goal of navigating to the secondary marker is weighted and considered at step 504. In embodiments, the navigation module 426 of the autonomous vehicle 404 implements step 514.

At step 515, the autonomous vehicle 404 retrieves (e.g., reads) data stored by the secondary marker. In one example, the autonomous vehicle 404 is a land-based vehicle with a clearance allowing for the automated vehicle 404 to drive over the secondary marker (e.g., 410C) and read the data stored in the marker using NDC reader of the data transfer module 425 located at a bottom side of the autonomous vehicle. In another example, a UAV may hover over the secondary marker, enabling a NDC reader at or adjacent to a bottom of the UAV to obtain data from the secondary marker. In embodiments, the data transfer module 425 of the autonomous vehicle 404 implements step 515.

At step 516, the autonomous vehicle 404 sends the navigation map, one or more updated ML algorithms and/or physical attributes obtained during the navigation event to the central server 406. This step enables the central server 406 to aggregate data from multiple autonomous vehicles 404 and provide multiple users with navigation maps for various exploration areas. In embodiments, after an autonomous vehicle 404 drops a marker 410, the autonomous vehicle 404 can return to a base (e.g., charging station) and upload navigational information to the central repository 406. In embodiments, the autonomous vehicle 404 sends the navigation map, one or more updated ML algorithms and/or physical attributes obtained during the navigation event to another autonomous vehicle 404 within a wireless communication range, or may push such data to one or more markers 410 so that the information can be accessed by other autonomous vehicles 404.

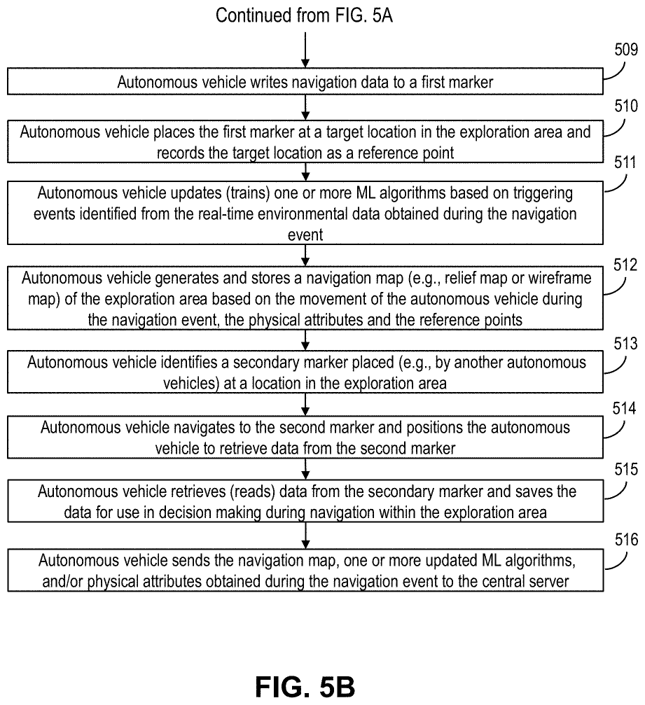

FIG. 6 shows a flowchart of an exemplary central server method in accordance with aspects of the present invention. Steps of the method may be carried out in the environment of FIG. 4 and are described with reference to elements depicted in FIG. 4. Unless otherwise indicated below, steps of FIG. 6 need not be performed in the order shown in the flowchart.

At step 600, the central server 406 sends one or more trained ML algorithms (e.g., an ML navigation algorithm or an ML environment algorithm) to a user or an autonomous vehicle 402 for use by the autonomous vehicle during a navigation event. In implementations, the user may select a type of environment to be explored (e.g., marsh, cave, underwater, land, etc.), and a matching ML algorithm may be provided to the user or the autonomous vehicle 402 by the central server 406. In embodiments, the data storage module 440 of the central server implements step 600.

At step 601, the central server 406 receives and stores a navigation map, one or more updated ML algorithms (e.g., an ML navigation algorithm or an ML environment algorithm), and/or physical attributes, from an autonomous vehicle 404. In implementations, the autonomous vehicle 404 stores information until it is in a network-enabled location, and sends stored data to the central server 406 via the network (network 402) once the network is enabled. In embodiments, the communications module 441 of the central server implements step 601.

At step 602, the central server 406 optionally updates (trains) one or more master ML algorithms (e.g., an ML navigation algorithm or an ML environment algorithm) based on the one or more updated ML algorithms received at step 601. In embodiments, the one or more trained algorithms sent to a user at step 600 comprise a master ML algorithm. In embodiments, the data storage module 440 of the central server implements step 602.

At step 603, the central server 406 sends (e.g., pushes) a stored navigation map to a hand-held navigation device 408 of a user. In embodiments, the communications module 441 of the central server implements step 603.

In implementations, the autonomous vehicle 404 is used to scout or reconnoiter a region (exploration area) and pre-lay navigational markers 410 to enable other autonomous vehicles 404 or hand-held device 408 users to navigate through the region. In one example, such a system can be utilized in a cave system for enabling rescuers (using hand-held devices 408) to follow a path to affect a rescue, without risking the rescuers getting lost in their search of the region.

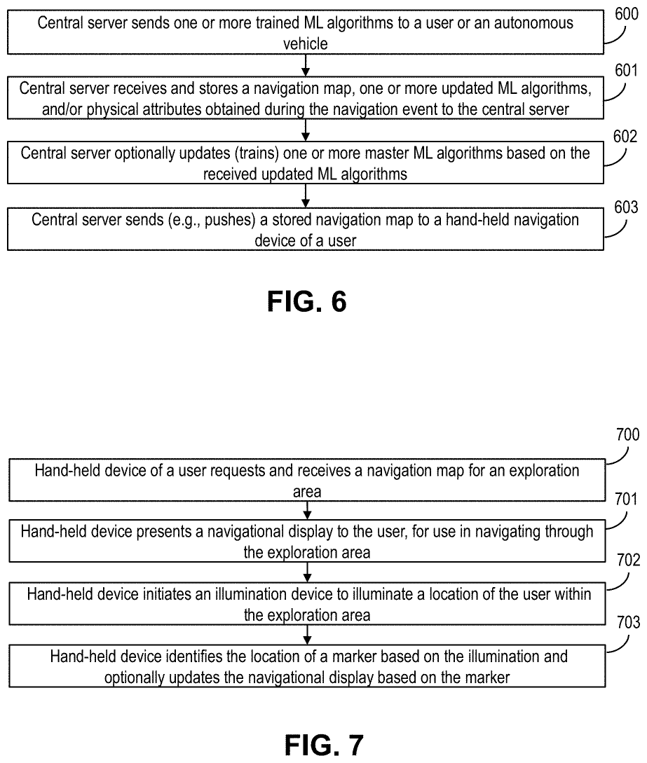

FIG. 7 shows a flowchart of an exemplary hand-held device method in accordance with aspects of the present invention. Steps of the method may be carried out in the environment of FIG. 4 and are described with reference to elements depicted in FIG. 4. Unless otherwise indicated below, steps of FIG. 7 need not be performed in the order shown in the flowchart.

At step 700, the hand-held device 408 of a user requests and receives a navigation map for an exploration area. In implementations, hand-held device 408 obtains the navigation map from the central server 406 when a network communication (e.g., network 402) is available. In embodiments, the tracking module 451 of the hand-held device 408 implements step 700.

At step 701, the hand-held device 408 of the user presents a navigational display to the user, for use in navigating through the exploration area based on the navigation map. Various navigational tools and methods may be utilized at step 701, and the present invention is not intended to be limited to a particular navigational tool or method.

At step 702, the hand-held device 408 of the user activates an illumination device (e.g., flashlight function of a mobile phone) to illuminate a location of the user within the exploration area. In embodiments, the illumination device 450 of the hand-held device 408 illuminates a location of the user.

At step 703, optionally, the hand-held device 408 identifies a location of a marker 410 within the area of exploration based on the illumination, and may update the navigational display based on the location of the marker. In embodiments, a user may visually identify one or more markers 410 placed within the exploration area based on reflection of light from the illumination device 450 off the reflective coating 412 of a marker 410C. In other embodiments, a sensor of the hand-held device 408 may sense reflection of light off the marker 410C and determined that location of the marker 410 based on the reflected light.

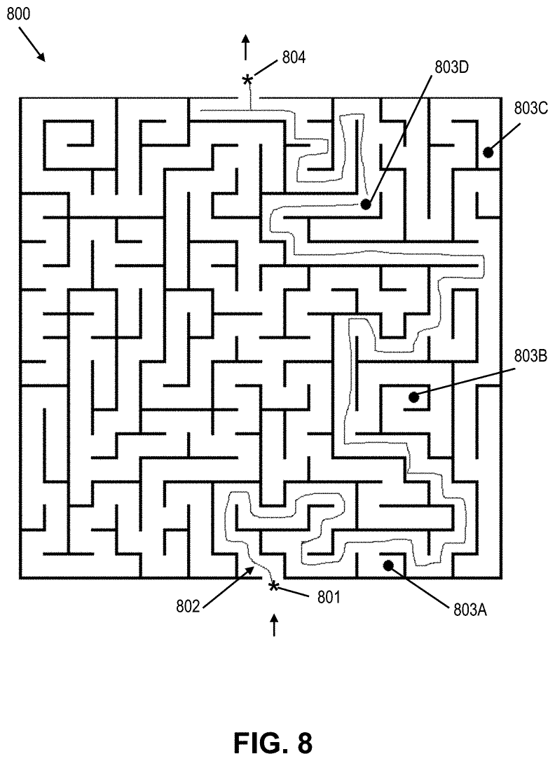

FIG. 8 is a diagram representing navigation through an obstacle-filled environment using a first maze solving method. FIG. 8 represents an exploration area 800, which could be a cave environment, for example. An autonomous vehicle 404 (e.g., a UAV not shown in FIG. 8) enters the exploration area 800 from a starting point 801, and navigates a path 802 through the exploration area 800 using a first method for solving a maze, wherein the autonomous vehicle 404 makes pre-determined direction based turns (i.e., follows the left wall or obstacle) to find its way from the starting point 801 to an end point 804 by the fastest route. While the first method is an efficient way to solve the maze, the first method attempts to minimize the distance traveled by the autonomous vehicle 404, and hence limits the exposure of the autonomous vehicle 404 to persons or objects 803A-803D at different locations within the exploration area 800. In the case of a search and rescue effort, for example, the goals of finding persons within the exploration area 800 would not be sufficiently met by the first method.

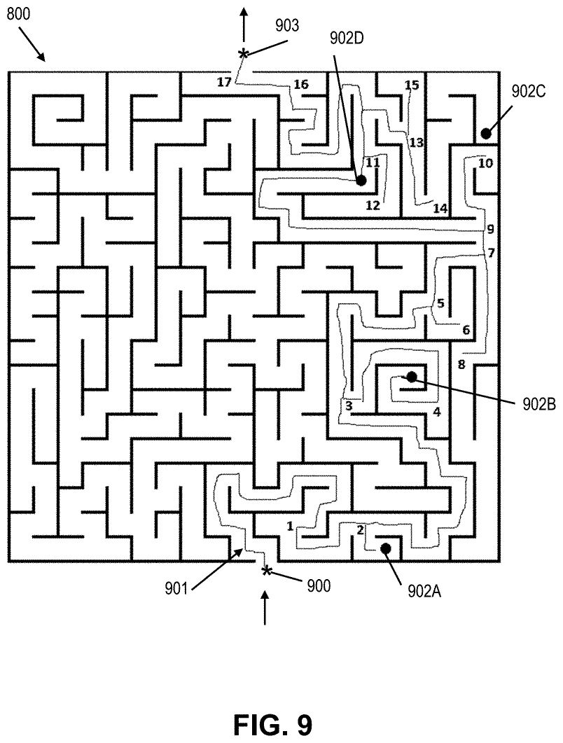

FIG. 9 is a diagram representing navigation through an obstacle-filled environment using a ML curiosity method in accordance with aspects of the invention. In implementations, a ML curiosity method is utilized which maximizes the efficiency in catering to multiple desired goals/outcomes (e.g., map terrain, finding a specific target, finding additional areas of interest, maximizing fuel usage, etc.). In the example of FIG. 9, an autonomous vehicle 404 (e.g., a UAV not shown in FIG. 9) enters the exploration area 800 from a starting point 900, and navigates a path 901 through the exploration area 800 using the ML curiosity method according to embodiments of the invention. Details of the ML curiosity method are shown in FIG. 5 at step 504 and substeps 504A-504E.

Still referring to FIG. 9, at each of the numbered points in the exploration area 800, a curiosity or ML decision is made, wherein a decision is based on the desired outcome to sample an alternate path weighted against a probability of success of one or more outcomes. The following exemplary decisions illustrate some possible outcomes of an autonomous vehicle 404 utilizing an ML curiosity method in accordance with embodiments of the invention.

At decision point 1, the autonomous vehicle 404 senses a dead end, chooses not to go straight, and turns left. At decision point 2, the autonomous vehicle 404 wanted to continue left, but sampled an alternative path, found the target (e.g., an object or person) indicated at 902A, sensed a dead end, and backtracked to the original decision point 2. At decision point 3, the autonomous vehicle 404 wanted to continue left, but sampled the alternative path. At decision point 4, the autonomous vehicle 404 determined that it was early in the navigation/journey and remaining fuel/power was high, knew the boundaries around the exploration area (having circled it already), checked for and found the target indicated at 902B, did not venture further south as it could sense a dead end, and backtracked to the original decision point 3. At decision point 5, the autonomous vehicle 404 wanted to continue left, but sampled an alternative path.

With continued reference to FIG. 9, at decision point 6, the autonomous vehicle 404 could see the path was a dead end, and thus did not explore further and backtracked to the original decision point 5. At decision point 7, the autonomous vehicle 404 wanted to continue left, but sampled an alternative path. At decision point 8, the autonomous vehicle 404 determined its fuel level, determined a large boundary was known from a portion of the exploration area already explored, and made a decision not to explore further based on a low curiosity regarding the area. At decision point 9, the autonomous vehicle 404 wanted to continue left, but sampled an alternative path. At decision point 10, the autonomous vehicle 404 could see the path was a dead end, and thus did not explore further and backtracked to the original decision point 9.

Still referencing FIG. 9, at decision point 11, the autonomous vehicle 404 wanted to continue left, but sample an alternative path. At decision point 12, the autonomous vehicle 404 could see the path was likely a dead end and the surrounding area had already been explored so halted exploration and backtracked to the original decision point 11. At decision point 13, the autonomous vehicle 404 wanted to continue left, but sampled an alternative path. At decision point 14, the autonomous vehicle 404 determined its fuel level was lower, there was no apparent end to the path, and decided not to explore further down the path (i.e., curiosity was low), and backtracked to the original decision point 13. At decision point 15, the autonomous vehicle 404 determined that the path was a dead end, and thus did not explore further and backtracked to the original decision point 13. At decision point 16, the autonomous vehicle 404 determined that the path was a dead end, and thus did not explore further. and at decision point 17, the autonomous vehicle 404 identified an exit, left the exploration area, and stopped recording the navigation at end point 903.

Based on the above, it can be understood that embodiments described herein enable the following: cartographical functions for mapping areas without GPS coverage or the like; electronic markers for data transfer and location reference points for the purpose of defining navigation markers; and improved search capabilities using one or more artificial intelligence (AI) ML algorithms (e.g., curiosity algorithm).

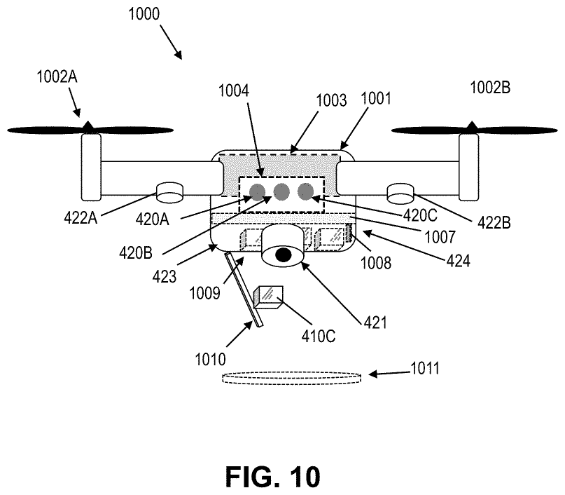

FIG. 10 illustrates an exemplary autonomous vehicle in accordance with aspects of the invention. It should be understood that various types of autonomous vehicles could be configured for use in embodiments of the invention, and the invention is not indented to be limited to a UAV 1000 as depicted in FIG. 10.

The UAV 1000 of FIG. 10 is depicted to show internal components within a housing 1001 in accordance with embodiments of the invention. In the example of FIG. 10, the UAV 1000 includes a propulsion system including propeller systems 1002A and 1002B and a motor represented at 1003 within the housing 1001 of the UAV 1000. A computer processor represented at 1004 is in communication with multiple sensors represented at 420A-420C, a digital camera 421, illumination devices 422A and 422B in the form of UV lights, and a NDC reader and writer represented at 1007. In the example shown, a marker placement device 424 includes mechanical arm 1008 that selectively moves to dispense a marker (e.g., 410C) through an opening 1009 in the marker storage area 423. The marker placement device 424 also includes a door 1010 selectively opened by the UAV100 to dispense and guide a marker 410C from the marker storage area 423 to a target location represented at 1011.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
continuously obtaining, by an autonomous vehicle, real-time environment data from one or more sensing devices of the autonomous vehicle during a navigation event in an exploration area;
identifying, by the autonomous vehicle, physical attributes of the exploration area based on an analysis of the real-time environmental data;
navigating, by the autonomous vehicle, within the exploration area during the navigation event using machine learning by:
assigning scores to multiple possible paths based on a probability of success of one or more desired outcomes for each of the possible paths;
selecting one of the possible paths based on the scores; and
moving the autonomous vehicle according to the selected one of the possible paths; and
building, by the autonomous vehicle, a navigation map of the exploration area based on the physical attributes.

2. The method of claim 1, further comprising identifying, by the autonomous vehicle, reference points based on the physical attributes of the exploration area, wherein the building the navigation map is further based on the reference points.

3. The method of claim 2, wherein the identifying the reference points is performed by a machine learning (ML) algorithm of the autonomous vehicle, wherein the ML algorithm identifies and distinguishes between fixed objects and non-fixed objects in the exploration area based the real-time environment data.

4. The method of claim 1, further comprising identifying, by the autonomous vehicle, a location within the exploration area for placement of a marker based on the physical attributes, wherein the marker stores digital data.

5. The method of claim 4, further comprising placing, by the autonomous vehicle, the marker at the identified location.

6. The method of claim 5, further comprising determining, by the autonomous vehicle, that a reference point cannot be identified based on the physical attributes of the exploration area, wherein the marker is placed in response to the determining that the reference point cannot be identified.

7. The method of claim 1, further comprising detecting, by the autonomous vehicle, a marker within the exploration area based on the real-time environment data, wherein the marker stores digital data.

8. The method of claim 7, further comprising navigating, by the autonomous vehicle, to the marker in response to the detecting the marker.

9. The method of claim 8, further comprising reading, by the autonomous vehicle, the digital data stored in the marker.

10. The method of claim 1, further comprising sending, by the autonomous vehicle, the navigation map to a central server accessible to other autonomous vehicles.

11. A computer program product comprising one or more computer readable storage media having program instructions collectively stored on the one or more computer readable storage media, the program instructions executable to cause an autonomous vehicle to:
continuously obtain real-time environment data from one or more sensing devices of the autonomous vehicle during a navigation event in an exploration area, wherein global positioning system (GPS) data is unavailable to the autonomous vehicle during the navigation event;
identify physical attributes of the exploration area based on an analysis of the real-time environmental data;
navigate within the exploration area during the navigation event using machine learning to select a path to travel from among multiple possible paths based on the physical attributes, wherein the navigating results in the autonomous vehicle changing directions while traveling through the exploration area during the navigation event;
building, by the autonomous vehicle, a navigation map of the exploration area over time during the navigation event based on the physical attributes;
writing digital data to a marker, the digital data providing information regarding the navigation; and
placing and leaving the marker at a target location in the exploration area.

12. The computer program product of claim 11, wherein the program instructions are further executable to cause the autonomous vehicle to identify reference points at locations within the exploration area based on the physical attributes of the exploration area, wherein the building the navigation map is further based on the reference points.

13. The computer program product of claim 12, wherein the identifying the reference points is performed by a machine learning (ML) algorithm of the autonomous vehicle, wherein the ML algorithm identifies and distinguishes between fixed objects and non-fixed objects in the exploration area based the real-time environment data.

14. The computer program product of claim 12, wherein the program instructions are further executable to cause the autonomous vehicle to:
determine that a reference point cannot be identified at a particular location in the exploration area based on the physical attributes, wherein the marker is placed at the target location in response to the determining that the reference point cannot be identified; and
record the target location as a reference point.

15. The computer program product of claim 11, wherein the program instructions are further executable to cause the autonomous vehicle to identify the target location in the exploration area for placement of the marker based on the physical attributes.

16. The computer program product of claim 11, wherein the program instructions are further executable to cause the autonomous vehicle to detect another marker within the exploration area based on the real-time environment data, wherein the other marker stores digital data.

17. The computer program product of claim 16, wherein the program instructions are further executable to cause the autonomous vehicle to navigate to the other marker in response to the detecting the marker.

18. A system comprising:
a processor, a computer readable memory, one or more computer readable storage media, and program instructions collectively stored on the one or more computer readable storage media, the program instructions executable to cause an autonomous vehicle to:
continuously obtain real-time environment data from one or more sensing devices of the autonomous vehicle during a navigation event in an exploration area, wherein global positioning system (GPS) data is unavailable to the autonomous vehicle during the navigation event;
identify physical attributes of the exploration area based on the real-time environmental data;
identify reference points based on the physical attributes of the exploration area using a trained machine learning (ML) algorithm;
navigate within the exploration area during the navigation event by:
assigning scores to multiple possible paths based on a probability of success of one or more desired outcomes for each of the possible paths;
selecting one of the possible paths based on the scores; and
moving the autonomous vehicle according to the selected one of the possible paths; and
build a navigation map of the exploration area over time during the navigation event based on the physical attributes and the reference points.

19. The system of claim 18, wherein the program instructions are further executable to cause an autonomous vehicle to:
at a point in time during the navigation event, write navigation data to a near device communication (NDC) enabled marker based on the navigation map at the point in time during the navigation event, wherein the NDC enabled marker includes a reflective coating; and
placing and leaving the NDC enabled marker at a target location in the exploration area, wherein the NDC enabled marker provides a visible reference point for future navigators of the exploration area and is configured to enable NDC devices to read the navigation data.

20. The system of claim 18, wherein the program instructions are further executable to cause an autonomous vehicle to determine, by the ML algorithm, the target location in the exploration area to place the NDC enabled marker based on the physical attributes of the exploration area.
